(19) United States
(12) Patent Application Publication
(10) Pub. No.: US 2009/0115699 A1
(43) Pub. Date: May 7, 2009

(54) Plasma display and driving method thereof

(76) Inventor: Kunio Takayama, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/289,814

(22) Filed: Nov. 5, 2008

(30) Foreign Application Priority Data
Nov. 6, 2007 (KR) 10-2007-0112709

(51) Int. Cl. G09G 3/28

(52) U.S. Cl. 345/60

(57) ABSTRACT

A method for driving a plasma display including a scan electrode and an address electrode crossing the scan electrode, the method including applying a scan pulse to the scan electrode and applying an address pulse to the address electrode when the scan pulse is applied to the address pulse. The address pulse has a first voltage and a second voltage. The scan pulse has a third voltage and a fourth voltage. A largest difference between voltages of the address pulse and the scan pulse is a difference between the first voltage and the fourth voltage. A point of time at which the scan pulse reaches the fourth voltage is equal to or later than a point of time at which the address pulse reaches the first voltage.

### BACKGROUND OF THE INVENTION

1. Field of the Invention

Embodiments relate to a plasma display device and a driving method thereof.

2. Description of the Related Art

A plasma display device is a display device using a plasma display panel to display characters or images by using plasma generated by a gas discharge. The plasma display panel includes a plurality of scan electrodes and a plurality of address electrodes crossing one another to form discharge cells.

A scan pulse is sequentially applied to the plurality of scan electrodes and an address pulse is selectively applied to the plurality of address electrodes in an address period of each subfield. At this time, an address discharge occurs in a cell having the scan pulse applied to the scan and the address pulse applied to the address electrode. Each light emitting cell is sustain discharged during a sustain period of each subfield so that images are displayed. The plasma display device may be driven by dividing a frame into a plurality of subfields each having a weight value, and displays a grayscale by a combination of weight values of subfields in which a display operation is generated among the plurality of subfields.

In general, since the scan and address electrodes operate as a capacitor, a capacitance is formed on the plasma display panel. Accordingly, when data applied to the address electrode is changed, since charge and discharge is repeated, reactive power is increased.

The above information disclosed in this Background section is only for enhancement of understanding of the background of the invention and therefore it may contain information that is not prior art.

### SUMMARY OF THE INVENTION

Embodiments are therefore directed to a plasma display device and a driving method thereof, which substantially overcome one or more of the problems and disadvantages of the related art.

It is therefore a feature of an embodiment to provide a plasma display device and a driving method thereof having reduced reactive power generated when an address pulse is applied to an address electrode.

It is therefore another feature of an embodiment to provide a plasma display device and a driving method thereof having a reduced probability that a weak discharge occurs between the scan electrode and the address electrode, so a sustain discharge may be maintained stably.

At least one of the above and other advantages and features may be realized by providing a method for driving a plasma display while dividing one frame into a plurality of subfields in the plasma display including a scan electrode and an address electrode crossing the scan electrode. According to the method, a scan pulse is applied to the scan electrode, and an address pulse is applied to the address electrode when the scan pulse is applied to the address pulse. The address pulse has a first voltage and a second voltage, the scan pulse has a third voltage and a fourth voltage, and a largest difference between voltages of the address pulse and the scan pulse being a difference between the first voltage and the fourth voltage. A point of time at which the scan pulse reaches the fourth voltage is equal to or later than a point of time at which the address pulse reaches the first voltage.

At least one of the above and other advantages and features may be realized by providing a plasma display including a scan electrode and an address electrode crossing the scan electrode. A power recovery capacitor is connected to the address electrode. A first driver is configured to apply a scan pulse to the scan electrode. A second driver including a first switch is configured to control a current path between the address electrode and the power recovery capacitor, the second driver configured to apply an address pulse to the address electrode. The address pulse has a first voltage and a second voltage, the scan pulse has a third voltage and a fourth voltage, a largest difference between voltages of the address pulse and the scan pulse being a difference between the first voltage and the fourth voltage. A point of time at which the scan pulse reaches the fourth voltage is equal to or later than a point of time at which the address pulse reaches the first voltage.

At least one of the above and other advantages and features may be realized by providing a method for driving a plasma display while dividing one frame into a plurality of subfields in the plasma display including a scan electrode and an address electrode crossing the scan electrode. The method include turning on a first switch for controlling a current path between the address electrode and a power recovery capacitor to change the voltage at the address electrode, applying a first voltage to the address electrode, turning on the first switch to change the voltage at the address electrode, applying a second voltage to the address electrode, and applying a third voltage to the scan electrode. A difference between the first and third voltages is larger than a difference between the first and second voltages. A point of time at which a voltage at the scan electrode reaches the third voltage is equal to or later than a point of time at which the voltage at the address electrode reaches the first voltage.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a plasma display device according to an exemplary embodiment of the present invention;

FIG. 2 illustrates a driving waveform according to an exemplary embodiment of the present invention;

FIG. 3 illustrates the address electrode driver according to the exemplary embodiment of the present invention;

FIG. 4 illustrates a signal timing of the switches shown in FIG. 3 according to an exemplary embodiment of the present invention;

FIG. 5A to FIG. 5D illustrate a current paths according to the signal timing shown in FIG. 4, respectively;

FIG. 6 illustrates a timing of a sustain pulse and an address pulse according to a first exemplary embodiment of the present invention;

FIG. 7 illustrates the scan electrode driver according to the exemplary embodiment of the present invention; and

FIG. 8 to FIG. 10 illustrate timings of a sustain pulse and an address pulse according to second to fourth exemplary embodiments of the present invention.

### DETAILED DESCRIPTION OF THE INVENTION

Korean Patent Application No. 10-2007-0112709 filed on Nov. 6, 2007, in the Korean Intellectual Property Office, and entitled: “Plasma Display and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Throughout this specification and the claims that follow, when it is described that an element is “connected” or “coupled” to another element, the element may be “directly connected” or “directly coupled” to the other element or “electrically connected” or “electrically coupled” to the other element through a third element. Unless explicitly described to the contrary, the word “comprise” and variations such as “comprises” or “comprising” will be understood to imply the inclusion of stated elements but not the exclusion of any other elements.

In addition, “wall charges” described herein mean charges formed and accumulated on a wall, e.g., a dielectric layer, close to an electrode of a discharge cell. A wall charge may be described as being “formed on” or “accumulated on” the electrode, or “formed in” or “accumulated in” the cell, although the wall charges may not actually touch the electrode or the cell. Further, a “wall voltage” means a potential difference formed on the wall of the discharge cell by the wall charge.

The plasma display device and driving method thereof according to exemplary embodiments of the present invention will now be described in detail.

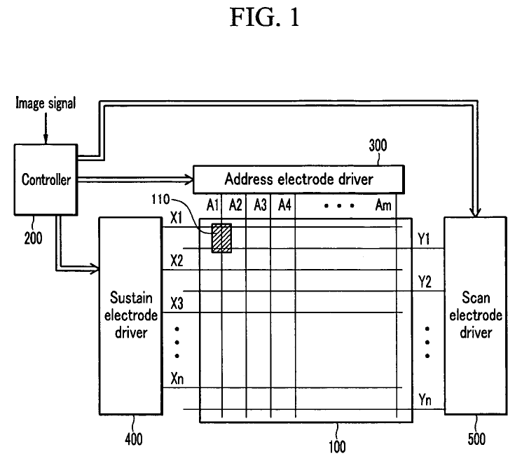

FIG. 1 illustrates a plasma display device according to an exemplary embodiment of the present invention. As shown in FIG. 1, the plasma display may include a plasma display panel 100, a controller 200, an address electrode driver 300, a sustain electrode driver 400, and a scan electrode driver 500.

The plasma display panel 100 may include a plurality of address electrodes A1-Am (referred to as “A electrodes” hereinafter) extending in a column direction, and a plurality of sustain electrodes X1-Xn (referred to as “X electrodes” hereinafter) and a plurality of scan electrodes Y1-Yn (referred to as “Y electrodes” hereinafter) extending in a row direction, in pairs. In general, the X electrodes X1-Xn may correspond to the respective Y electrodes Y1-Yn, and the X electrodes X1-Xn and the Y electrodes Y1-Yn may perform a display operation during a sustain period in order to display an image.

The Y electrodes Y1-Yn and the X electrodes X1-Xn may cross the A electrodes A1-Am. A discharge space at each crossing area of the A electrodes A1˜Am and the X and Y electrodes X1˜Xn and Y1˜Yn may form a discharge cell 110. The structure of the PDP 100 is only one example, and embodiments are not limited thereto. PDPs having various structures to which driving waveforms described herein may be applied may also be applicable in the present invention.

The controller 200 may receive an image signal from the outside and may output an A electrode driving control signal, an X electrode driving control signal, and a Y electrode driving control signal. Further, the controller 200 may drive a frame by dividing it into a plurality of subfields each having a weight value.

The address electrode driver 300 may receive the A electrode driving control signal from the controller 200 and may apply a driving voltage to the A electrodes A1-Am. The sustain electrode driver 400 may receive the X electrode driving control signal from the controller 200 and may apply a driving voltage to the X electrodes X1-Xn. The scan electrode driver 500 may receive the Y electrode driving control signal from the controller 200 and may apply a driving voltage to the Y electrodes Y1-Yn.

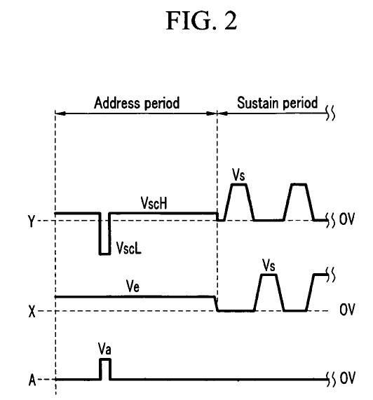

FIG. 2 illustrates a driving waveform according to an exemplary embodiment of the present invention. In FIG. 2, only an A electrode, an X electrode, and a Y electrode are illustrated for better understanding and ease of description. In FIG. 2, the driving waveform will be described with a cell formed by an A electrode, an X electrode, and a Y electrode as a reference.

As shown in FIG. 2, during the address period, in order to select a light emitting cell, the sustain electrode driver 400 may maintain the voltage of the X electrode at a voltage Ve, and the scan electrode driver 500 and the address electrode driver 300 may apply a scan pulse having a voltage VscL and an address pulse having a voltage Va to the Y electrode and the A electrode, respectively. The scan electrode driver 500 may supply a non-selected Y electrode with the voltage VscH that is higher than the voltage VscL, and the address electrode driver 300 may supply the A electrode of a non-light emitting cell with the reference voltage (0V in FIG. 2). The voltage VscL may be equal to or less than a firing voltage Vnf (not shown).

In detail, during the address period, the scan electrode driver 500 may apply scan pulses to the Y electrode of a first row (Y1 in FIG. 1). At the same time, the address electrode driver 300 may apply address pulses to the A electrodes positioned at light emitting cells in the first row.

Then, an address discharge may occur between the Y electrode of the first row and the A electrodes to which the address pulses have been supplied, forming positive (+) wall charges in the Y electrode of the first electrode and negative (−) wall charges in the A and X electrodes. Subsequently, while the scan electrode driver 500 applies scan pulses to the Y electrode of a second row (Y2 in FIG. 1), the address electrode driver 300 may apply address pulses to the A electrodes positioned at light emitting cells of the second row. Then, address discharges may occur at cells formed by the A electrodes to which the address pulses have been applied and the Y electrode of the second row, forming wall charges in the cells. Likewise, while the scan electrode driver 500 sequentially applies scan pulses to the Y electrodes of the remaining rows, the address electrode driver 300 may apply address pulses to the A electrodes positioned at light emitting cells to form wall charges.

During the sustain period, the scan electrode driver 500 may apply the sustain pulse alternately having a high level voltage (Vs in FIG. 2) and a low level voltage (0V in FIG. 2) to the Y electrodes a number of times corresponding to a weight value of the corresponding subfield. The sustain electrode driver 400 may apply a sustain pulse to the X electrodes in a phase opposite to that of the sustain pulse applied to the Y electrodes. That is, 0V is applied to the X electrode when a Vs voltage is applied to the Y electrode, and the Vs voltage is applied to the X electrode when 0V is applied to the Y electrode. Thus, the voltage difference between the Y electrode and the X electrode alternately is Vs voltage and −Vs voltage. Accordingly, the sustain discharge may repeatedly occur at light emitting cells as many times as the predetermined number.

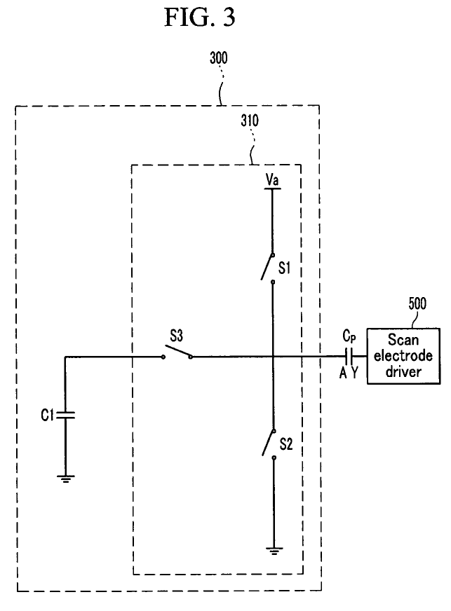

Next, the address electrode driver 300 that can reduce reactive power generated when an address pulse is applied to an address electrode will be described with reference to FIG. 3. FIG. 3 illustrates the address electrode driver 300 according to an exemplary embodiment of the present invention.

As shown in FIG. 3, the address electrode driver 300 may include at least one power recovery capacitor C1, and a plurality of address driving circuits 310 respectively connected to the A electrodes A1 to Am shown in FIG. 1. The address driving circuit 320 includes a driving switch S1, a grounding switch S2, and a power recovery switch S3. In FIG. 3, for better understanding and ease of description, only an address driving circuit connected to one A electrode is illustrated, and a capacitive component formed by the A electrode and the Y electrode Y is shown as a panel capacitor Cp. Among the plurality of address driving circuits 310, a predetermined number of address driving circuits 310 may be integrated into an integrated circuit (IC).

The IC may be mounted on a packaging connection member, e.g., a tape carrier package (TCP) in a chip. The packaging connection member may be bonded to the plasma display panel 100 and a printed circuit board (PCB) of the address electrode driver 300. In this case, the power recovery capacitor C1 may be mounted in the PCB and be connected to the IC on the packaging connection member.

Further, at least one power recovery capacitor C1 may be commonly connected to the plurality of address driving circuits 310 respectively connected to the plurality of address electrodes (A1 to Am in FIG. 1). Alternatively, another power recovery capacitor C1 may be connected to the predetermined number of address driving circuits (for example, an integrated circuit including the predetermined number of address driving circuits) for every address driving circuit. In this case, it is assumed that a capacitance of the power recovery capacitor C1 is larger than a capacitance of the panel capacitor Cp. Thus, a variation of the voltage of the power recovery capacitor C1 due to a current charged or discharged from the panel capacitor Cp when the switch S3 is turned on is small. Further, it is assumed that the power recovery capacitor C1 supplies a voltage between an address voltage Va and a voltage of 0V, in particular, of about half of the address voltage Va.

Again, as shown in FIG. 3, a first terminal of the driving switch S1 may be connected to a power source Va for supplying a high level voltage of the address pulse (i.e., the address voltage Va), and a second terminal of the driving switch S1 may be connected to the A electrode. A first terminal of the grounding switch S2 may be connected to a power source for supplying a low level voltage of the address pulse (i.e., a non-address voltage, 0V in FIG. 2), and a second terminal of the grounding switch S2 may be connected to the A electrode. A second terminal of the power recovery switch S3 of which a first terminal is connected to the power recovery capacitor C1 may be connected to the A electrode.

In FIG. 3, a field effect transistor may be used as each of the switches S1, S2, and S3, or different switches having the same or similar function may be used as the switches S1, S3, and S3. Also, when transistors with a body diode are used as the switches S1, S2, and S3, two transistors connected in a back-to-back pattern may be used as the switch to block a current path in which the power recovery capacitor C1 is charged or discharged by the body diodes.

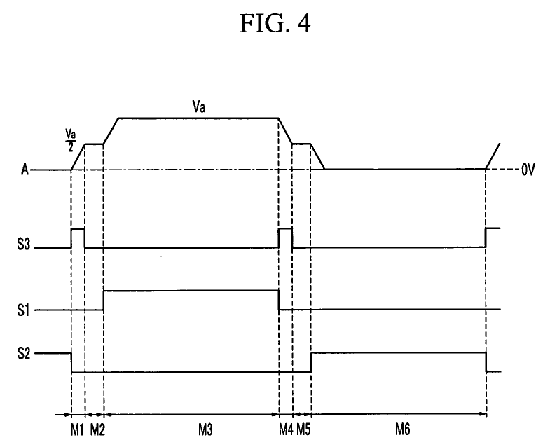

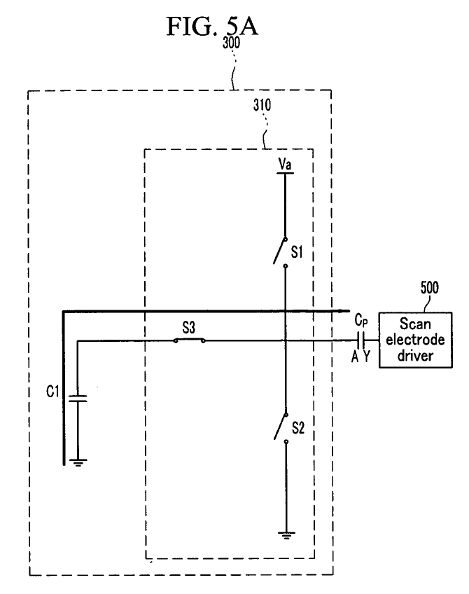

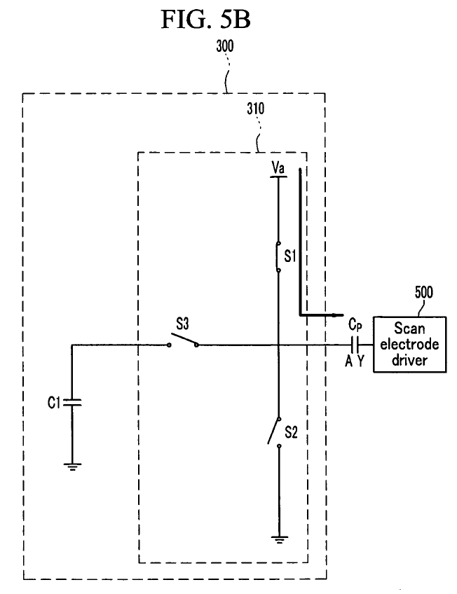

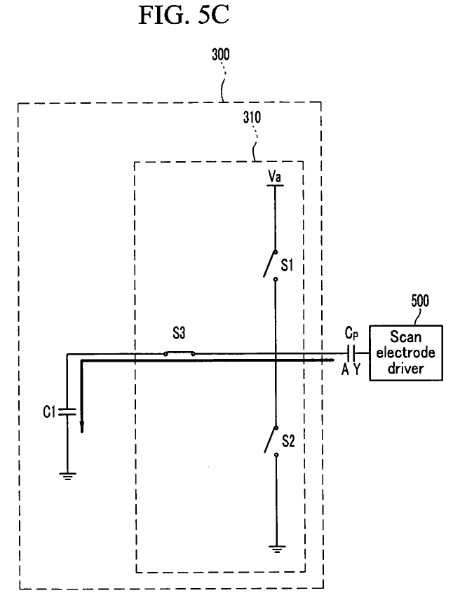

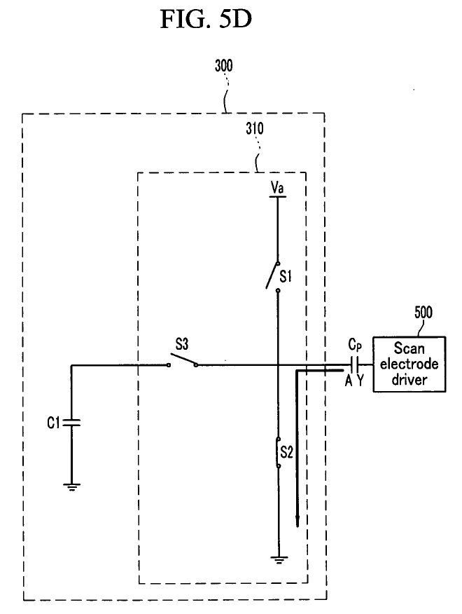

Operation of the address electrode driver 300 according to a control signal of the controller 200 will now be described in accordance with an embodiment with reference to FIG. 4 and FIG. 5A to FIG. 5D. FIG. 4 illustrates signal timing of the switches shown in FIG. 3. FIG. 5A to FIG. 5D illustrate a current path according to the signal timing shown in FIG. 4, respectively.

For example, it is assumed that the grounding switch S2 is turned on, so the ground voltage 0V is applied to the A electrode before a first mode M1 is started. As shown in FIG. 4, in the first mode M1, the grounding switch S2 may be turned off and the power recovery switch S3 may be turned on.

Then, as shown in FIG. 5A, a voltage charged in the power recovery capacitor C1 is directly charged to the panel capacitor Cp through a current path of the power recovery capacitor C1, the power recovery switch S3, and the panel capacitor Cp. Accordingly, a voltage at the A electrode may increase from the 0V voltage to a voltage that is close to a predetermined voltage. The voltage at the A electrode is determined by a turning on time of the power recovery switch S3.

The voltage at the A electrode may increase to the Va/2 voltage when assuming that half of the voltage Va is charged in the power recovery capacitor C1, and capacitance of the power recovery capacitor C1 is large. Further, when the voltage of the power recovery capacitor C1 is directly charged in the panel capacitor Cp, a charging time may be reduced to be shorter than a time for charging the panel capacitor Cp by using resonance of an external inductor and the panel capacitor Cp.

As shown in FIG. 4, in a third mode M3, the power recovery switch S3 may be off and the driving switch S1 may be turned on. Then, as shown in FIG. 5B, the voltage Va is applied to the A electrode of the panel capacitor Cp through a path of a power source Va, the driving switch S1, and the panel capacitor Cp.

As shown in FIG. 4, in a fourth mode M4, the driving switch S1 may be turned off and the power recovery switch S3 may be turned on. Then, as shown in FIG. 5C, the voltage charged in the panel capacitor Cp may be recovered to the power recovery capacitor C1 through a path of the panel capacitor Cp, the power recovery switch S3, and the power recovery capacitor C1. Accordingly, the voltage at the A electrode may decrease from the voltage Va to approach the predetermined voltage. When it is assumed that the capacitance of the power recovery capacitor C1 is large, the voltage at the A electrode may be decreased to the voltage Va/2.

Subsequently, as shown in FIG. 4, in a sixth mode M6, the power recovery switch S3 may be off and the grounding switch S2 may be turned on. Then, as shown in FIG. 5D, the voltage 0V is applied to the A electrode of the panel capacitor Cp through a path of the panel capacitor Cp, the grounding switch S2, and the ground terminal.

In addition, the A electrode may be floated during a second mode M2, between the first mode M1 and the third mode M3, and during a fifth mode M5, between the fourth mode M4 and the sixth mode M6. Without the floating period during the second mode M2, the driving switch S1 and the power recovery switch S3 may be simultaneously turned on because of a reverse recovery time of the power recovery switch S3. Accordingly, the address electrode driver 300 may have an operational problem. Likewise, without the floating during the fifth mode M5, the grounding switch S2 and the power recovery switch S3 may be simultaneously turned on because of a reverse recovery time of the power recovery switch S3. Then, since the voltage charged in the power recovery capacitor C1 is discharged through the grounding switch S2, the address electrode driver 300 may have an operational problem. Accordingly, when the A electrode is floated in the second mode M2 and the fifth mode M5, respectively, the driving switch S1 and the power recovery switch S3 may be prevented from being simultaneously turned on, and the grounding switch S2 and the power recovery switch S3 may be prevented from being simultaneously turned on.

The first mode M1 to the sixth mode M6 may operate when data applied to the A electrode varies.

For example, the first mode M1 to the sixth mode M6 may be operated when the 0V voltage is applied to the A electrode during a period (before the first mode M1 begins) for applying the scan pulse to a first Y electrode (Y1 in FIG. 1), the Va voltage may be applied to the A electrode during a period (the third mode M3) for applying the scan pulse to a second Y electrode (Y2 in FIG. 1), and the 0V voltage may be applied to the A electrode during a period (the sixth mode M6) for applying the scan pulse to a third Y electrode (Y3 in FIG. 1). However, the Va voltage may be continuously applied to the A electrode without the fourth mode and the fifth mode M5 (i.e., without reducing the voltage at the A electrode) when the Va voltage is applied to the A electrode during periods (the third and sixth modes M3 and M6) for applying the scan pulse to the second and third scan electrodes (Y2 and Y3 in FIG. 1).

Likewise, when the 0V voltage is applied to the A electrode without the first mode M1 and the second mode M2 (i.e., without increasing the voltage at the A electrode) when the 0V voltage is applied to the A electrode during periods (before the first mode M1 begins and the third mode M3) for applying the scan pulse to the first and second scan electrodes (Y1 and Y2 in FIG. 1).

Thus, even if data applied to the A electrode varies, since the address electrode driver 300 according to the exemplary embodiment of the present invention recovers and reuses the reactive power using the power recovery capacitor C1, expended reactive power may be reduced.

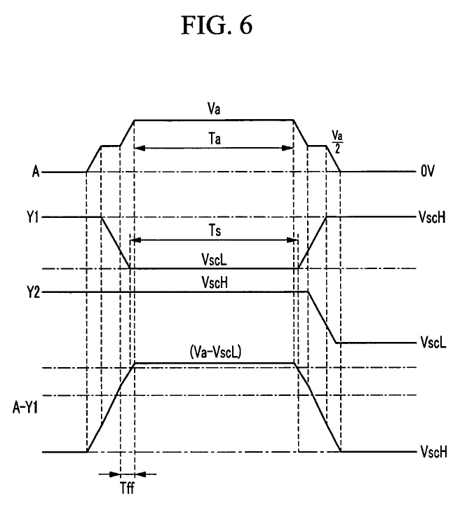

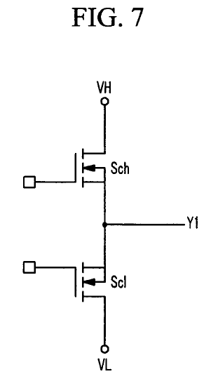

FIG. 6 illustrates a timing of a sustain pulse and an address pulse according to a first exemplary embodiment of the present invention, and FIG. 7 illustrates the scan electrode driver according to the exemplary embodiment of the present invention.

As shown in FIG. 6, when the data applied to the A electrode varies, the plurality of address driving circuit 310 respectively connected to the A electrodes (A1-Am in FIG. 1) may simultaneously turn on the power recovery switch S3. Further, as shown in FIG. 7, the scan electrode driver 500 may include two switches Sch and Scl. Each first terminal of each switch Sch and Scl may be connected to a Y electrode (Y1-Yn in FIG. 1), a second terminal of the switch Sch may be connected to a high voltage terminal VH, and a second terminal of the switch Scl may be connected to a low voltage terminal VL. The high voltage terminal VH may be connected to a power source (not shown) for supplying the voltage VscH, and the low voltage terminal VL may be connected to a power source (not shown) for supplying the voltage VscL. FIG. 7 shows the switches connected the Y electrode Y1 among the Y electrodes Y1-Yn.

As shown in FIG. 6, the scan electrode driver 500 may turn on the switch Scl to apply the voltage VscL to the Y electrode Y1, and then may turn on the switch Sch to apply the voltage VscH to the Y electrode Y1. At this time, the voltage VscL and the Voltage VscH, i.e., the scan pulse is applied to the Y electrode Y1 by hard switching of the switches Scl and Sch. The scan electrode driver 500 turns off/turns on the switches Scl/Sch connected to the Y electrode Y1, and, simultaneously, may turn on/turn off the switches Scl/Sch connected to the Y electrode Y2 to apply the scan pulse to the Y electrode Y2. Thus, the voltage of the scan pulse applied to the Y electrode Y1 begins to decrease in the second mode M2 and begins to increase in the fifth mode M5, and the voltage of the scan pulse applied to the Y electrode Y2 begins to decrease in the fifth mode M5.

Since the scan electrode driver 500 may apply the scan pulse using hard switching, the voltage of the scan pulse may decrease from the voltage VscL and the voltage VscH during the second mode M2 and may increase from the voltage VscL to the voltage VscH during the fifth mode M5. Thus, a width Ts of the scan pulse may be longer than a width Ta of the address pulse. Here, the width Ts is a period in which the voltage at the Y electrode is substantially maintained at the voltage VscL, and the width Ta is a period in which the voltage at the A electrode is substantially maintained at the voltage Va.

The voltage at the A electrode increases from the voltage Va/2 to the voltage Va when the voltage at the Y electrode approaches the voltage VscL. Thus, address discharge may occur during a period Tff in which a voltage difference between the A electrode and the Y electrode is greater than predetermined voltage, i.e., a discharge firing voltage between the A electrode and the Y electrode. Since the voltage at the A electrode changes in the period Tff, a weak address discharge may occur in the period Tff. A sustain discharge may be difficult to maintain in the sustain period after a weak address discharge has occurred.

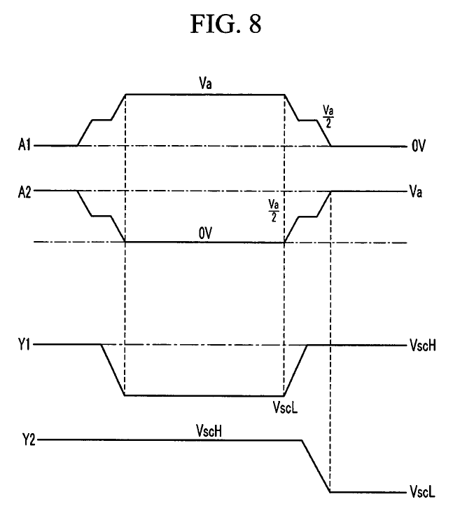

Next, an exemplary embodiment for reducing generation of the weak address discharge will be described in detail with reference FIGS. 8 to 10.

FIGS. 8 to 10 illustrate timings of a sustain pulse and an address pulse according to second to fourth exemplary embodiments of the present invention. FIG. 8 to FIG. 10 illustrate two Y electrodes Y1 and Y2 among Y electrodes (Y1-Yn in FIG. 1), and two A electrodes A1 and A2 among A electrodes (A1-Am in FIG. 1) for better understanding and ease of description. Further, it is assumed that data applied to the A electrodes A1 and A2 changes.

First, as shown in FIG. 8, the power recovery switch (S3 in FIG. 3) may be simultaneously turned on in the address driving circuits (310 in FIG. 3) respectively connected to the A electrodes A1 and A2 when the voltage Va is applied to the A electrode A1 and the voltage 0V is applied to the A electrode A2. At this time, the scan electrode driver 500 may set timing of turning the switches Scl and Sch connected to the Y electrode Y1 on and off to be later than that in FIG. 6, so that the voltage of the scan pulse applied to the Y electrode Y1 may reach the voltage VscL at a point of time equal to or later than a point of time at which the voltage of the address pulse reaches the voltage Va.

Likewise, the scan electrode driver 500 may set timing of turning the switches Scl and Sch connected to the Y electrode Y2 on and off to be later than that in FIG. 6, so that the voltage of the scan pulse applied to the Y electrode Y2 may reach the voltage VscL at a point of time equal to or later than a point of time at which the voltage of the address pulse reaches the voltage Va.

At this time, the scan electrode driver 500 may set timing of turning the switches Scl and Sch connected to the Y electrode Y2 on and off after the switch Scl connected to the Y electrode Y1 is turned off. At the same time, the switch Sch connected to the Y electrode Y1 may be turned on to change the voltage at the Y electrode Y1 to the voltage VscH.

Then, compared with FIG. 6, the period Tff, in which a voltage difference between the A electrode and the Y electrode is greater than the discharge firing voltage between the A electrode and the Y electrode, may be reduced or eliminated. Accordingly, compared with FIG. 6, a probability that a weak discharge occurs is reduced.

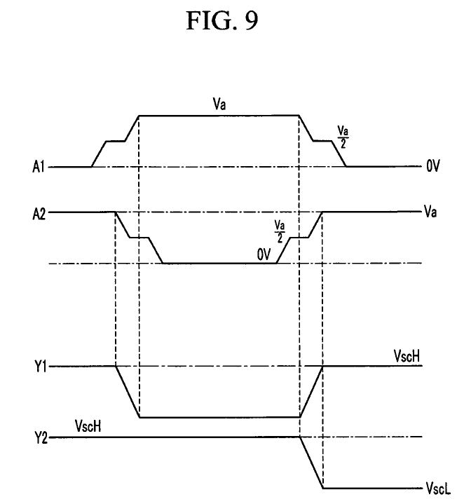

Meanwhile, as shown in FIG. 9, the power recovery switch (S3 in FIG. 3) may not be simultaneously turned on in the address driving circuits (310 in FIG. 3) respectively connected to the A electrodes A1 and A2 when the voltage Va is applied to the A electrode A1 and the voltage 0V is applied to the A electrode A2. That is, the power recovery switch S3 connected to the A electrode A2 may be turned on after the power recovery switch S3 connected to the A electrode A1 is turned on, so that the voltage at A electrodes A1 and A2 may respectively increase from the voltage 0V to half of the voltage Va. Further, the power recovery switch S3 connected to the A electrode A1 may be turned on after the power recovery switch S3 connected to the A electrode A2 is turned on, so that the voltage at the A electrodes A1 and A2 may respectively decrease from half of the voltage Va to the voltage 0V.

At this time, the scan electrode driver 500 may set timing of turning the switches Scl and Sch connected to the Y electrode Y1 on and off to be later than that in FIG. 6, so that the voltage of the scan pulse applied to the Y electrode Y1 reaches the voltage VscL at a point of time equal to or later than a point of time at which the voltage of the address pulse reaches the voltage Va.

Likewise, the scan electrode driver 500 may set timing of turning the switches Scl and Sch connected to the Y electrode Y2 on and off to be later than that in FIG. 6, so that the voltage of the scan pulse applied to the Y electrode Y2 reaches the voltage VscL at a point of time equal to or later than a point of time at which the voltage of the address pulse reaches the voltage Va.

At this time, the timing of turning the switches Scl and Sch connected to the Y electrode Y1 off and on may be the same as the timing of turning the switches Scl and Sch connected to the Y electrode Y2 on and off.

In this case, compared with FIG. 6, the period Tff, in which a voltage difference between the A electrode and the Y electrode is greater than the discharge firing voltage between the A electrode and the Y electrode, may be reduced or eliminated.

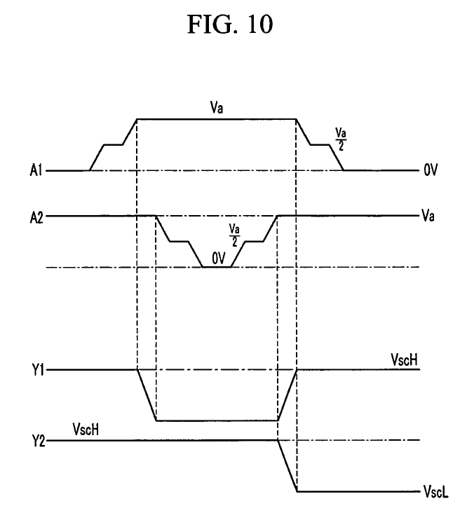

In addition, as shown in FIG. 10, when the voltage Va is applied to the A electrode A1, and the voltage 0V is applied to the A electrode A2, the voltage at the A electrode A2 may decrease from the voltage Va to the voltage 0V, and then the voltage at the A electrode A2 may be maintained at the voltage 0V. Subsequently, the voltage at the A electrode A2 may increase from the voltage 0V to the voltage Va during a period in which the A electrode A1 is maintained at the voltage Va.

At this time, the scan electrode driver 500 may set timing of turning the switches Scl and Sch connected to the Y electrode Y1 on and off to increase the voltage of the scan pulse applied to the Y electrode Y1 from the voltage VscH to the voltage VscL at a point of time at which the voltage of the address pulse reaches the voltage Va. Likewise, the scan electrode driver 500 may set timing of turning the switches Scl and Sch connected to the Y electrode Y2 on and off to decrease the voltage of the scan pulse applied to the Y electrode Y2 from the voltage VscH to the voltage VscL at the point of time at which the voltage of the address pulse reaches the voltage Va.

Then, compared with the first to third exemplary embodiments, since timing of turning on and off the switches Scl and Sch on and off is late, the period Tff in which a voltage difference between the A electrode and the Y electrode is greater than the discharge firing voltage between the A electrode and the Y electrode may be reduced or eliminated.

Exemplary embodiments of the present invention have been disclosed herein, and although specific terms are employed, they are used and are to be interpreted in a generic and descriptive sense only and not for purpose of limitation. For example, relative differences between voltage levels at the electrodes are of interest, not the absolute voltage levels separately. For example, the address pulse may be considered to have a first voltage, e.g., a first high voltage, and a second voltage, e.g., a first low voltage, and the scan pulse may be considered to have a third voltage, e.g., a second high voltage, and a fourth voltage, e.g., a second low voltage, wherein a largest difference between voltages of the address pulse and the scan pulse is a difference between the first voltage and the fourth voltage. Thus, the pulses applied may differ from the specific examples used above. Accordingly, it will be understood by those of ordinary skill in the art that various changes in form and details may be made without departing from the spirit and scope of the present invention as set forth in the following claims.

What is claimed is:

1. A method for driving a plasma display including a scan electrode and an address electrode crossing the scan electrode, the method comprising:
applying a scan pulse to the scan electrode; and
applying an address pulse to the address electrode when the scan pulse is applied to the address pulse, wherein:
the address pulse has a first voltage and a second voltage,
the scan pulse has a third voltage and a fourth voltage, a largest difference between voltages of the address pulse and the scan pulse being a difference between the first voltage and the fourth voltage, and
a point of time at which the scan pulse reaches the fourth voltage is equal to or later than a point of time at which the address pulse reaches the first voltage.

2. The method as claimed in claim 1, wherein applying the address pulse includes:
turning on a switch for controlling a current path between the address electrode and a power recovery capacitor to change the voltage at the address electrode;
applying the first voltage to the address electrode;
turning on the switch to change the voltage at the address electrode; and
applying the second voltage to the address electrode,
wherein applying the scan pulse includes changing the voltage at the scan electrode to the fourth voltage after the voltage at the address electrode reaches the first voltage.

3. The method as claimed in claim 2, wherein changing the voltage at the scan electrode to the fourth voltage occurs after changing the voltage at the scan electrode to the third voltage.

4. The method as claimed in claim 2, further comprising:
floating the address electrode before applying the first voltage to the address electrode; and
floating the address electrode before applying the second voltage to the address electrode.

5. The method as claimed in claim 2, wherein:
applying the first voltage to the address electrode includes turning on a second switch connected between the address electrode and a first power source for supplying the first voltage; and
applying the second voltage to the address electrode includes turning on a third switch connected between the address electrode and a second power source for supplying the second voltage.

6. The method as claimed in claim 2, wherein applying the scan pulse includes:
turning on a second switch connected to the scan electrode to apply the fourth voltage to the scan electrode; and
turning on a third switch connected to the scan electrode to apply the third voltage to the scan electrode when turned on,
wherein the second switch is turned on once the address pulse reaches the first voltage.

7. A plasma display, comprising:
a scan electrode;
an address electrode crossing the scan electrode;
a power recovery capacitor connected to the address electrode;
a first driver configured to apply a scan pulse to the scan electrode; and
a second driver including a first switch configured to control a current path between the address electrode and the power recovery capacitor, the second driver configured to apply an address pulse to the address electrode, wherein
the address pulse has a first voltage and a second voltage,
the scan pulse has a third voltage and a fourth voltage, a largest difference between voltages of the address pulse and the scan pulse being a difference between the first voltage and the fourth voltage, and
a point of time at which the scan pulse reaches the fourth voltage is equal to or later than a point of time at which the address pulse reaches the first voltage.

8. The plasma display as claimed in claim 7, wherein the second driver is configured to turn on the first switch to change the voltage at the address electrode to the second voltage when the first driver changes the voltage at the scan electrode to the third voltage.

9. The plasma display as claimed in claim 7, wherein the first driver includes:
a second switch connected to the scan electrode and configured to apply the fourth voltage to the scan electrode when turned on; and
a third switch connected to the scan electrode and configured to apply the third voltage to the scan electrode when turned on,
wherein the second switch is turned on once the address pulse reaches the first voltage.

10. The plasma display as claimed in claim 7, wherein the second driver includes:
a second switch connected between a first power source for supplying the first voltage and the address electrode; and
a third switch connected between a second power source for supplying the second voltage and the address electrode.

11. The plasma display as claimed in claim 10, wherein the first switch, the second switch, and the third switch are an integrated circuit.

12. The plasma display as claimed in claim 10, further comprising:
a packaging connection member configured to connect the address electrode and the power recovery capacitor,
wherein the address driving circuit is mounted on the packaging connection member.

13. The plasma display as claimed in claim 12, wherein the packaging connection member includes a tape carrier package.

14. A method for driving a plasma display including a scan electrode and an address electrode crossing the scan electrode, the method comprising:
turning on a first switch for controlling a current path between the address electrode and a power recovery capacitor to change the voltage at the address electrode;
applying a first voltage to the address electrode;
turning on the first switch to change the voltage at the address electrode;
applying a second voltage to the address electrode; and
applying a third voltage to the scan electrode, a difference between the first and third voltages being larger than a difference between the first and second voltages, wherein a point of time at which a voltage at the scan electrode reaches the third voltage is equal to or later than a point of time at which the voltage at the address electrode reaches the first voltage.

15. The method as claimed in claim 14, wherein applying the third voltage includes changing the voltage at the scan electrode to the third voltage after the voltage at the address electrode reaches the first voltage.

16. The method as claimed in claim 15, wherein turning on the first switch occurs after the voltage at the scan electrode changes from the third voltage to a fourth voltage having a value closer to the first voltage than the third voltage.

17. The method as claimed in claim 14, wherein:
applying the first voltage to the address electrode includes turning on a second switch connected between the address electrode and a first power source for supplying the first voltage; and
applying the second voltage to the address electrode includes turning on a third switch connected between the address electrode and a second power source for supplying the second voltage.

18. The method as claimed in claim 14, wherein the first switch, the second switch and the third switch are an integrated circuit.

19. The method as claimed in claim 14, further comprising:
floating the address electrode before applying the first voltage to the address electrode; and
floating the address electrode before applying the second voltage to the address electrode.
